(19) United States
(12) Patent Application Publication
(10) Pub. No.: US 2007/0196320 A1
(43) Pub. Date: Aug. 23, 2007

(54) Bioadhesive compositions and their use in medical electrodes

(76) Inventor: Mohammed Yasin, Birmingham (GB)

Correspondence Address: David Silverstein;Andover-Ip-Law, Suite 300, 44 Park Street, Andover, MA, 01810, US

(21) Appl. No.: 10/589,601

(22) PCT Filed: Feb. 16, 2005
(86) PCT No.: PCT/GB05/50017

§ 371 Date: Sep. 29, 2006

(30) Foreign Application Priority Data
Feb. 18, 2004 (GB) 04 035 10.1

(51) Int. Cl. A01N 25/24

(52) U.S. Cl. 424/77

(57) ABSTRACT

This invention relates to bioadhesive compositions, which are particularly, but not exclusively, useful for making medical electrodes and to medical electrodes based on such compositions. A first bioadhesive composition comprises: 10 (i) 28-60 wt % of a copolymer comprising repeating units derived from one or more monomers selected from olefinically unsaturated sulphonic acids and repeating units derived from one or more olefinically unsaturated carboxylic acids, the ratio by weight of the sulphonic acid units to the carboxylic acid units being from 30:1 to 1:1; 15 (b).

### FIELD OF THE INVENTION

This invention relates to bioadhesive compositions which are particularly, but not exclusively, useful for making medical electrodes, and to medical electrodes based on such compositions.

### BACKGROUND TO THE INVENTION

Hydrogels are finding considerable use in biomedical applications. Synthetic hydrogels that have bioadhesive properties are finding increased use as conductors, allowing electrical connection between the skin and external medical equipment. The water in the hydrogel provides an ideal medium for dissolution of electrically conductive inorganic salts, thus increasing the electrical conductivity of the hydrogel and its role as a biomedical skin electrode. The external medical equipment can be a transcutaneous electric nerve stimulation device, electric muscle stimulation device, electrocardiogram device or monitoring device.

U.S. Pat. No. 4,273,135 (Larimore, Minn. Mining and Manufacturing) discloses a “dry” biomedical electrode that does not require cream or gel to enhance conductivity between the skin and the electrode plate. The electrode is of resistance 100 kΩ or less at 10 Hz and has on its body-contacting surface a dermally non-irritating conformable cohesive non-ionic synthetic hydrophilic polymer containing at least 15 mole % of a water-soluble monomer that preferably acts as a pressure-sensitive adhesive. The term “cohesive” implies that the film-forming material is more cohesive than it is skin-adherent so that it can be removed from the skin without leaving an objectionable residue. Electrode materials that were tested include polyacrylic acid plasticised with glycerol, polyvinyl alcohol either alone or plasticised with glycerol, a methyl vinyl ether/maleic acid copolymer plasticised with glycerol and copolymers of e.g. isooctyl acrylate and acrylic acid. Both tack-free and tacky films were provided.

U.S. Pat. No. 4,539,996 (Engel, Minn. Mining and Manufacturing) discloses a further dry biomedical electrode in which the electrode material is “solventless” in the sense that there are essentially no materials present in the precursor which are not present in the final composition of the electrically conductive adhesive The material is made by UV polymerization and incorporates cross-linked polymers which permit higher amounts of polyhydric alcohol (e.g. 50-70%) without reducing viscosity below acceptable levels. In an example, a composition based on acrylic acid (25 g), glycerol (50 g), tetraethylene glycol bis-methacrylate (0.1 g), aqueous sodium hydroxide (7 g in 10 ml) and photoinitiator was knife-coated onto an aluminium substrate and cured under a bank of UV lamps, see also U.S. Pat. No. 4,554,924 (Engel, Minn. Mining and Manufacturing) which discloses materials containing ionizable salts and suitable for ECG electrodes.

U.S. Pat. No. 3,929,741 (Lakey, Datascope) discloses hydrophilic acrylamido polymers obtained by polymerization of acrylamidoalkyl-sulfonic acid monomers and capable of ingurgitating large quantities of liquids, particularly water as well as saline and biological fluids, without dissolution of the polymer network. The polymers include copolymers with many different types of co-monomer including
Esters of unsaturated polyhydric alcohols (e.g. butenediol).
Vinyl cyclic compounds (e.g. styrene, vinyl furan, N-vinyl pyrrolidone).
Unsaturated acids (e.g. acrylic, methacrylic, propacrylic acid).
Unsaturated anhydrides (e.g. maleic, citraconic, itaconic).
Unsaturated nitrites (e.g. acrylonitrile, methacrylonitrile).
Unsaturated amines (e.g. acrylamide, dimethylaminoethyl methacrylate).
Vinyl halides (e.g. vinyl chloride, vinyl iodide, allyl chloride).
Unsaturated ketones (e.g. methyl vinyl ketone, ethyl vinyl ketone).
Unsaturated ethers (e.g. methyl vinyl ether, diallyl ether).
Unsaturated esters (e.g. hydroxyethyl methacrylate, hydroxypropyl acrylate).
Unsaturated finctional silanes.
Alkyl methacrylates (e.g. methyl methacrylate, ethyl methacrylate).

U.S. Pat. No. 4,391,278 (Cahalan, Medtronic) discloses a biomedical electrode in which the skin-contacting material is an adhesive based on a polymer or copolymer of 2-acrylamido-2-methyl-1-propanesulfonic acid or a salt thereof together with water, an alcohol (preferably glycerol or propylene glycol) or a mixture thereof. Polymerization is by addition of a free-radical initiator such as ferrous sulfate and hydrogen peroxide and is also a “solventless” process in the sense defined in U.S. Pat. No. 4,539,996. One example uses 2-acrylamido-2-methyl-1-propanesulfonic acid (25 g), acrylic acid (4 g) and water (25 g) together with small amounts of initiator. The skin-contacting material is said to be inherently electrically conductive so that it does not require electrically conductive additives. It is also said to possess superior adhesive properties, uniform electrical characteristics, adhesive properties that can resist appreciable skin moisture so that the electrodes can be used for several days at a time and homogeneity and creep-resistance so that development of “hot spots” is avoided. U.S. Pat. No. 4,768,523 (Cahalan et al., Lifecore Biomedical) discloses similar materials made from 2-acrylamido-2-methyl-1-propanesulfonic acid with methylene bis-acrylamide as crosslinking agent and dried to a water content of 2-30 wt % which are aggressively adhesive on initial skin contact and can be used e.g. for attaching pacing leads to epicardial tissue and other moist internal tissue.

Cationic hydrogels made from cationic acrylates e.g. acryloyloxyethyl trimethylammonium chloride and 3-acrylamidopropyltrimethylamrnmonium chloride which are non-corrosive to aluminium and can be used for defibrillation and cardiac pacing are disclosed in U.S. Pat. No. 5,800,685 (Perrault, Cardiotronics Systems).

U.S. Pat. No. 5,173,302 (Holmblad et al., Medtronic) is concerned inter alia with polymerizable formulations curable to produce adhesives on a backing that can be used as a reservoir for topically or transdermally administrable drugs. The adhesives comprise (a) 20%-50% of a monofunctional monomer component at least 75% of which comprising 2-acrylamido-2-methylpropane sulphonic acid or a salt thereof, the balance being selected from acrylic acid, water soluble acrylic functional monomers and vinyl pyrrolidone, (b) 30%-50% of a glycol component selected from the group consisting of compounds of formula HO—(C₂H₄O)ₙ—H, HO—(C₃H₆O)ₘ—H and mixtures thereof, where n is 4-16 and m is 1-4, (c) between about 0.02% and about 0.20% of a crosslinking monomer and an amount of a free radical polymerization initiator effective to initiate polymerization of the monofunctional monomer and crosslinking monomer components and (d) water. In an example, a gel material was prepared by combining (where parts are by weight):

45.25 parts of a 58% solution of NaAMPS in water;

8 parts of a 1% N,N-methylene-bis-acrylamide solution in water;

a drug/humectant premix comprising 39.60 parts polyethylene glycol M.W.=300 (PEG 300) and 0.99 parts hydrocortisone;

silica, 2.48 parts;

acrylic acid, 2.77 parts; and

photoinitiator (Irgacure.™. 184), 1 part of a 3% solution in isopropanol). The degassed mixture was coated through a mesh reinforcement layer of spunbonded polyester onto a polyester sheet material (5 mil Mylar™) and cured with UV radiation of 1.77 mW/cm² from a 365 nm Hg vapour lamp for 1.5 minutes. The cured gel had sufficient adhesion to remain on skin for at least 8 hours.

JP-A-6200224 discloses a new high-adhesion hydrogel composition obtainable by UV-copolymerization of 20-60 parts by weight of 2-acrylamido-2-methyl propane sulphonic acid and/or a salt thereof and 0.03-0.08 parts by weight of a crosslinling monomer at a pH of 5.5 or above in a mixture comprising 20-60 parts by weight of a polyhydric alcohol and 10-50 parts by weight of an aqueous medium In an example, 38 g of sodium 2-acrylamide-2-methyl propane sulphonate was dissolved in 23.6 g of deionized water, which was pH-adjusted to 6.0. To the mixture there were added 38 g glycerol, 0.020-0.10 parts by weight of methylene bisacrylaride as a crosslinking monomer and 150 ppm relative to the amount of the solution of benzoin ethyl ether as a photoinitiator. The ingredients were mixed thoroughly and de-foamed in vacuo, after which the resulting solution was poured into a mould frame, sealed with a polyester film and irradiated with the light from a 15 W low-pressure mercury lamp at room temperature for 15 min. to bring about polymerization. The resulting hydrogel composition exhibited good adhesion and was low in residual monomers.

U.S. Pat. No. 6,447,798 (Munro et al, First Water Limited) discloses weakly bioadhesive hydrogel compositions suitable for use as wound dressings because they loose adhesion on water uptake. In particular, it discloses a water unstable bioadhesive composition comprising (i) a water activity in the range of 0.4 to 0.9; (ii) an elastic modulus at 1 rad/s in the range of 700 to 15,000 Pa; (iii) an elastic modulus at 100 rad/s in the range of 2000 to 40,000 Pa; (iv) a viscous modulus at 1 rad/s in the range of 400 to 14,000 Pa; and (v) a viscous modulus at 100 rad/s in the range of 1000 to 35,000 Pa, wherein the viscous modulus is less than the elastic modulus in the frequency range of 1 to 100 rad/s.

US-A-2002/0015689 and WO 00/46319 (Munro et al., First Water) are concerned with the provision of hydrogel electrodes for adhesion to wet or moist skin and in particular for adhesion to skin to which an artificial layer of grease has been applied e.g. from a moisturising skin cream. For this purpose there is employed a bioadhesive composition formed by polymerising a homogeneous aqueous reaction mixture comprising from about 5% to about 50%, by weight of the reaction mixture, of at least one ionic water soluble monomer, from about 10% to about 50%, by weight of the reaction mixture, of at least one plasticiser (other than water), up to about 50%, by weight of the reaction mixture, of at least one non-ionic water soluble monomer and up to about 40%, by weight of the reaction mixture, of water. The water-soluble monomer is preferably NaAMPS. The plasticiser comprises a polyhydric alcohol (such as glycerol), an ester derived therefrom and/or a polymeric alcohol, for example polyethylene oxide. All the disclosed non-ionic water-soluble monomers are mono- or di-N-alkylacrylamides or analogues thereof The term “analogue” in this context refers to non-ionic water-soluble monomers containing an alkyl or substituted alkyl group linked to a carbon-carbon double bond via an amido or alkylamido (—CO.NH— or —CO.NR—) function. Examples of such analogues include diacetone acrylamide (N-1,1-dimethyl-3-oxobutyl-acrylamide), N-alkylated acrylamides, N,N-dialkylated acrylamides, N-vinyl pyrrolidone and acryloyl morpholine. The use of monomers of this type gives rise to handling difficulties because at least some are suspected of being carcinogenic, and they have offensive odours, so that they may need to be handled using breathing masks. The compositions are alleged to exhibit “water stability” which is defined to mean the maintenance of adhesion to skin or another substrate from a level of 50% to more than 100% of the value of the “as made” hydrogel adhesive when the water content of the hydrogel has increased by absorption of water (from the environment external to the hydrogel). To provide adhesion to greasy skin the reaction mixture also preferably comprises from about 1% to about 15 wt % of a hydrophobic non-water soluble monomer which may, for example be n-butyl acrylate, n-butyl methacrylate, a hexyl acrylate, iso-octyl acrylate, isodecyl acrylate, ethoxyethyl acrylate tehrahydrofurfuryl acrylate, vinyl propionate and vinyl butyrate. One exemplified composition is based on NaAMPS, N,N-dimethylacrylamide, glycerol and polyethylene glycol (400) diacrylate.

WO 00/06214 (Munro et al., First Water) discloses hydrogel adhesives for skin electrodes having controlled and predictable adhesive properties and defined in terms of viscoelastic properties and water-activity which should be within the range 0.4 to 0.9 and which should contain both non-freezing and freezing water within the gel. The gels are made from a first monomer which is an acrylamido-alkylsulphonic acid or salt thereof e.g. 2-acrylamido-2-methyl-1-propanesulfonic acid sodium salt (NAPS) and a second monomer which is an acrylic acid sulphoalkyl ester or salt thereof e.g. acrylic acid 3-sulphopropyl ester (SPA), potassium salt, preferably in a ratio of 10:1 to 2:3. Comonomers may be present including acrylic acid or a salt or ester thereof. One of the compositions mentioned in an Example comprises 58 parts NaAMPS (50% aqueous solution), 2 parts of SPA, 1.575 parts of acrylic acid and 37 parts of water together with photoinitiator. However, the properties of the resulting cured composition are not described.

### SUMMARY OF THE INVENTlON

Conductive soft bioadhesive hydrogels in the patent literature have very high water content. One object of the invention is to provide hydrogels in which the bioadhesive and electrical conductivity are not controlled by the water content of the hydrogel, but by the chemical composition of the formulation, in particular the type and level of monomer(s) and plasticiser(s), and in which the architecture of the polymer network developed and thus the physical properties of the hydrogel depend on the type and level of monomers and plasticiser(s) being used. This allows the development of soft, skin friendly, electrically conductive bioadhesive hydrogels

We have found that bioadhesive hydrogels having a desirable combination of properties are obtainable by polymerising an aqueous mixture of two or more water-soluble monomers, aqueous plasticiser and cross-linking agent. In particular, acrylic acid is a water-soluble monomer that is commonly used in the development of pressure sensitive adhesives, hydrogels and bioadhesive hydrogels. We have found that copolymerisation of acrylic acid with sodium acrylamido tertiary butyl sulfonate (NaAMPS or ATBS-Na) produces hydrogels with usefull properties. ATBS-Na is sold as a 50% or 58% solution in water and the available materials provide a useful source of both monomer and water. The total level of the water in the formulation, and hence water content in the final hydrogel can be controlled by the amount of ATBS-Na (as 50% or 58% solution) in the formulation as no water is removed during the processing stage.

In one aspect the invention provides a bioadhesive composition comprising: (i) 28-60 wt % (e.g. 32-52 wt %) of a copolymer comprising repeating units derived from one or more monomers selected from olefinically unsaturated sulphonic acids and repeating units derived from one or more olefinically unsaturated carboxylic acids, the ratio by weight of the sulphonic acid units to the carboxylic acid units being from 30:1 to 1:1; (ii) 20-45 wt % (e.g. 25-45 wt %) of plasticizer(s); and (iii) 10-55 wt %o (e.g. 10-35 wt %) of water; the balance being electrolyte (if any) and optional ingredients.

In a further aspect the invention provides a bioadhesive composition comprising: (a) 28-60 wto/o (e.g. 32-52 wt %) of a polymer based on repeating units derived from one or more monomers selected from olefinically unsaturated sulphonic acids; (b) 20-45 wt % (e.g. 25-45 wt %) of plasticizer(s); (c) 10-55 wt % (e.g. 10-35 wt %) of water; and (d) at least one of an alkoxy polyethyleneglycol acrylate or methacrylate, β-caboxyethyl acrylate, acryroyl oxyethyl tnmethyl ammonium chloride or 3-acrylamidopropyl trimethyl ammonium chloride, the balance being electrolyte (if any) and optional ingredients.

In an alternative aspect, the invention provides a bioadhesive composition comprising: (a) a copolymer comprising repeating units derived from (i) one or more monomers selected from olefinically unsaturated sulphonic acids (ii) one or more olefinically unsaturated carboxylic acids, the ratio by weight of the sulphonic acid units to the carboxylic acid units being from 30:1 to 1:1; (b) a water-soluble polyhydric alcohol that is liquid at ambient temperatures; (c) a mono- or di-ester of polyethylene glycol with a fatty acid e.g. lauric, myristic, palmitic, stearic, oleic, arachidic or erucic acid; and (d) water.

In a further alternative aspect, the invention provides a bioadhesive composition comprising: (a) a copolymer comprising repeating units derived from (i) one or more monomers selected from olefinically unsaturated sulphonic acids (ii) one or more olefinically unsaturated carboxylic acids, the ratio by weight of the sulphonic acid units to the carboxylic acid units being from 30:1 to 1:1, and (iii) β-carboxyethyl acrylate; (b) at least one plasticiser; and (c) water.

The invention also provides uncured compositions for UV-curing into any of the above e.g. an uncured composition including as photoinitiator a mixture of an oligomeric α-hydroxyketone and 2-hydroxy-2-methyl-1-pbenyl-1-propanone. The invention also provides a method for manufacturing a bioadhesive composition as aforesaid which comprises providing said uncured composition and subjecting said composition to curing with UV light.

In a yet further aspect the invention provides a medical electrode, bandage or the like having an adhesive layer as set out above.

### DESCRIPTION OF PREFERRED EMBODIMENTS

By selection of the appropriate monomer(s) and their level(s) and the right combination of plasticiser level, hydrogels with a wide spectrum of properties can be developed; from hydrogels being soft, comfortable and easy to remove after a few hours of skin contact to hydrogels increasing their adhesion as they absorb body moisture, to those that have the ability of adhering to oily skin. Certain embodiments of the above bioadhesive composition provide the only gels that we have so far found that work at all in sweaty conditions. Generally, the best current commercially available electrode starts to fall off the skin after only about 30 minutes use in conditions where the ambient temperature is about 30° C. and there is significant humidity. In extreme exercise conditions the commercial electrodes hardly adhere at all. However, certain electrodes made using gels of the invention have stayed on and continued to work for hours even in very sweaty conditions. Embodiments of the present gel seem to survive and retain their power of adhesion even after more that 100 uses in normal conditions whereas the best current commercial product is basically worn out after about 60 uses even under favourable conditions.

A significant property of certain embodiments of the present hydrogels is that they increase in adhesion with uptake of water because the gels are “water-starved”. The present gels may become softer with water uptake e.g. on repeated re-use while maintaining their adhesive properties and leaving no or substantially no residue, whereas existing gels are prone to dry out with prolonged storage or use. The water activity of the gels (defined as the free water in the system) in many embodiments is from less than 0.4 to as low as 0.2, although water activities of up to about 0.65 and even up to about 0.9 may be possible in some embodiments. Embodiments of the present gels have relatively low elastic modulus and relatively high viscous elastic modulus due to the use of a low molecular weight PEG type plasticiser. Levels of plasticiser content can be used to control the softness of the gel.

In many compositions of the invention, the copolymer is present in an amount of 35-42 wt % based on the weight of the organic materials and water present.

For hydrogel compositions containing polymerized ATBS-Na, it may be desirable to control the level of unreacted ATBS-Na, and also the level of impurities such as acrylonitrile, acrylamide, and t-butyl acrylamide, present as monomers in the ATBS starting material. This is so that the level of acrylonitrile, acrylamide, and t-butyl acrylamide are kept within specifically defined target levels in the eventually resulting hydrogel composition, see EP-A-1245241.

Strong Acid Monomers

A first and predominant type of repeating unit present in the copolymer is derived from one or more monomers selected from olefinically unsaturated sulphonic acids. A preferred class of such acids is of the formula 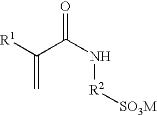
in which: R¹ represents hydrogen, methyl or ethyl; R² represents a hydrocarbon moiety (e.g. of 3-12 carbon atoms, preferably 3-6 carbon atoms and especially —CR³R⁴—CH₂— wherein R³ and R⁴ represent hydrogen or straight or branched C₁-C₆ alkyl); and M represents a physiologically acceptable cation.

Acrylamidoalkyl sulfonic acids include 2-acrylamidoethanesulphonic acid, 2-acrylamidopropanesulphonic acid, 2-acrylamido-2-methylethane sulfonic acid, 2-acrylamido-2-methylpropane sulfonic acid, 2-acrylamido-2-methylbutane sulfonic acid, etc. Methacrylamidoalkyl sulfonic acids include for example, 2-methacrylamido-2-methylethane sulfonic acid, 2-methacrylamido-2-methylpropane sulfonic acid, 2-methacrylamido-2-methylbutane sulfonic acid and alkali metal (for example, Na, K, etc.) or ammonium ion salts of these acids. Of this class, a preferred member is acrylamido-2-methyl-1-propanesulfonic acid which may be employed as a salt thereof e.g. its lithium, sodium, potassium or ammonium salt. The sodium salt (NaAMPS) 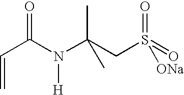
is available from Lubrizol as a 50% aqueous solution (LZ2405) or as a 58% aqueous solution (LZ2405A). The same monomer is available from Toagosei under the name sodium acrylamido tertiary butyl sulfonate (ATBS-Na) and both products share CAS number 5165-97-9.

A further olefinically unsaturated sulphonic acid of a different class is 3-sulphopropyl acrylate (SPA), which may be used as a salt or analogue. Its sodium salt is of formula: 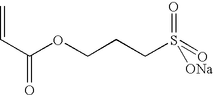
and has been found to impart softness to gels in which it is contained and to give good water absorption properties. Gels can also be made incorporating Acryl-(3-sulfopropyl)-ester, potassium salt (SPA), CAS No 31098-20-1, which is also referred to as acrylic acid (3-sulfopropyl) ester, potassium salt or 3-sulfopropyl acrylate, potassium salt.

Yet further olefinically unsaturated sulphonic acids include, for example, 3-sulphopropyl methacrylate, 2-sulphoethyl acrylate, 2-sulphoethyl methacrylate, vinylsulphonic acid, styrenesulphonic acid, vinyltoluene sulphonic acid and methacrylic sulphonic acid.

The above monomer units may occur individually or together with e.g. acrylamido-2-methyl-1-propanesulfonic acid or a salt thereof predominating and minor amounts of 3-sulphopropyl acrylate (SPA) or a salt thereof or another of the monomers mentioned above being copolymerised. However, compositions based on acrylamido-2-methyl-1-propanesulfonic acid or a lithium, sodium, potassium or ammonium salt thereof as sole strongly acidic monomer are preferred.

Weak Acid and Neutral Monomers

Suitable weak-acid monomers preferably present as a minor component of the copolymer include those selected from olefinically unsaturated carboxylic acids such as acrylic acid, methacyclic acid, maleic acid, itaconic acid, crotonic acid, ethacrylic acid, citroconic acid, fumaric acid, sterylacrylic acid and the like. The above monomer units may occur individually or in admixture. Acrylic acid and methacrylic acid, polyacrylic acid and mixtures thereof are particularly preferred weak-acid monomers, and alkali metal and ammonium salts e.g. sodium or potassium salts may also be used.

For most purposes, the ratio by weight of the sulphonic acid units to the carboxylic acid units is in the range 2.5:1 to 12:1. The presence of acrylic acid has been found to promote the adhesiveness of the gel. However, we have found that with high levels of acrylic acid and low levels of ATBS-Na, the hydrogel produced is stiff, has low bioadhesive properties and does not conform to the skin. With high levels of ATBS-Na and low levels of acrylic acid, the hydrogel has good flexibility but looses its adhesion after being on the skin for several times.

We have found that addition of β-carboxyethyl acrylate [CH₂═CH—CO—O—(CH₂—CH₂—CO—O)ₙH where n=1] to a copolymer based on repeating units derived from one or more monomers selected from olefinically unsaturated sulphonic acids and repeating units derived from one or more olefinically unsaturated carboxylic acids can impart softness, flexibility and adhesiveness to the composition. The β-carboxyethyl acrylate may be added in amounts of 1-10 wt %, typically about 5-8 wt %. For example, the above effects effect have been observed in hydrogels produced on addition of up to 10% β-carboxyethyl acrylate (product of Rhodia and sold under the trade name of Sipomer β CEA) to a mixture of 30% ATBS-Na and 4% acrylic acid and are also noted in other hydrogels exemplified herein.

We have also found that the introduction of 0.1 to 20%, preferably 0.5 to 10 (e.g. 0.5 to 2) wt % of an alkoxy polyethyleneglycol acrylate or methacrylate into a copolymer based on repeating units derived from one or more monomers selected from olefinically unsaturated sulphonic acids and repeating units derived from one or more olefinically unsaturated carboxylic acids such as acrylic acid or another non-glycol derived fatty acid can surprisingly improve reusability (number of times that the hydrogel can be adhered to the skin) and flexibility. The polyethylene glycol moiety in said compounds may have a molecular weight of from 200-1000, preferably 300-700. Such compounds include methoxy polyethylene glycol (350) monoacrylate, methoxy polyethylene glycol (550) monoacrylate, methoxy polyethylene glycol (350) monomethacrylate and methoxy polyethylene glycol (550) monomethacrylate, the lower molecular weight compounds being preferred. Methoxy polyethylene glycol (350) monoacrylate and methacrylate have good water solubility, low Tg (e.g about −50° C.) and fast surface cure. The low Tg provides a cured material that is flexible at room temperature and even more flexible at body temperature, and therefore contributes significantly to re-usability and softness. Addition of up to 1% methoxy polyethylene glycol (350) monoacrylate (product of Sartomer and sold under the trade name of Sartomer CD-551) has proved effective in increasing hydrogel reusability. We believe this is also due to the incorporation of long side chains into the 3 dimensional structured polymer network hydrogel produced by co-polymerisation of ATBS-Na and acrylic acid with the methoxy polyethylene glycol (350) monoacrylate (Sartomer CD 551) and optionally with Sipomer β CEA.

Cationic Monomers

The introduction of small amounts of cationic olefinic comonomers, for example acrylamidoalkyl trimethyl ammonium salts and acryloyloxyalkyl trimethylammonium salts may be used for adjusting electrical performance and/or gel strength. Examples include acryroyloxyethyl trimethyl ammonium chloride (DAC) (or 2-(dimethylamino) ethyl acrylate, methyl chloride quaternary salt; product of Toagosei Chemicals and sold under the trade name of ARON DAC; CAS no 44992-01-0) or 3-acrylamidopropyl trimethyl ammonium chloride (ATC; CAS no 45021-77-0) typically in amounts of 0.1% to 15%, more typically 0.1% to 5%, which made a small contribution to the electrical performance and the physical strength of the hydrogel produced.

Plasticisers

In most compositions, plasticizer content is present in an amount of 20-45 wt % (e.g. 280-45 wt %) based on the weight of the organic materials and water present, preferably 25-40 wt %. The plasticizer should be water-soluble and liquid at ambient temperatures (20° C.). It is preferred to use glycerol because it makes the cured composition resistant to dehydration, imparts softness, improves shelf life and does not tend to leach out. It is also inexpensive, biocompatible and generally regarded as safe. There may also be mentioned other polyols such as propylene glycol, 1,2,4 butane triol, polyethylene oxide and higher-melting polyols that can be dissolved in low melting polyol to give a mixture that is liquid at ambient temperatures. Ethylene glycol is not preferred because it can give rise to adverse dermal reactions. When glycerol is present as in polymerized hydrogel adhesives made by UV curing, the level of acrolein in the finished composition may also need to be controlled and kept under defined target levels, see EP-A-1245241.

Surprisingly, hydrogels with combined properties of softness and reusability were prepared when blends of glycerol and polyethylene glycol mono- and di-esters were used. Such esters may be mono-or diesters of polyethylene glycol with a fatty acid e.g. lauric, myristic, palnitic, stearic, oleic, arachidic or erucic acid.

In contrast to WO 00/06214 where plasticisers (glycerol and PEG 600) are used to control adhesive properties, in the present adhesive materials polyethylene glycol laureate/oleate (ideally molecular weight 400 or 600) and the like are used as plasticizer with glycerol to control the softness of the hydrogel, whereas the adhesion properties are controlled by the amount of total monomer present, in particular the amount of acrylic acid or other simple non-glycol fatty acid. The addition of polyethylene glycol esters at a level of about 3% of the total plasticizer surprisingly imparts new properties—the hydrogel not only becomes very soft but can stick to oily and sweaty skin, i.e. skin on which natural body oils are present. In this case, the polyethylene glycol esters also start to behave as surfactants.

Particular polyethylene glycol esters based on PEG of e.g MW 200-1000 (pref 300-600) include polyethylene 400 glycol dilaurate, polyethylene 400 glycol monolaurate, polyethylene 600 glycol monolaurate, polyethylene 400 glycol monooleate, polyethylene 600 glycol monooleate, polyethylene 400 glycol dioleate and polyethylene 600 glycol dioleate) and blends thereof The preferred polyethylene glycol esters are based on PEG 400 or 600, liquid at room temperature and water soluble. The level of these in the formulation could be from 20% to 0.1%, ideally 10% to 0.5%. Increasing the level of polyethylene glycol ester above 5% of the total plasticiser in a formulation decreased the adhesion of the hydrogel dramatically, which is not preferred for a medical electrode adhesive, but would be ideal for applications where bioadhesive of the hydrogel is less important, such as in a wound dressing. The plasticizer (e.g. glycerol and polyethylene glycol esters) is incorporated into the bioadhesive-forming composition before that composition is polymerised.

Water Content

The amount of water desired in the composition will vary widely depending upon the other materials present, but in many compositions falls within the range 20-35 wt %, especially about 27-33 wt % water which is relatively low and assists adhesion to individuals who are perspiring e.g. because of hot and high humidity climatic conditions or because of physical exercise. Water that is incorporated into the hydrogel is at the formulation stage and no water is added (or taken out), during the curing stage. Frequently the sulphonate monomer(s) will be provided in aqueous solution, and the water in which the monomer is dissolved will provide the entire water content of the cured composition. Hydrogels with close to or less than 25 wt % water and in particular less than 20 wt % of water content when they are deficient in water (“starved”) exhibit the novel and surprising result that the level of adhesion of the hydrogel increases as the body starts to sweat. Conventional hydrogels decrease their adhesive performance as the skin becomes sweaty, and can fall off the skin.

The low water content of the sheet hydrogels produced was, surprisingly, acceptable in using these type of hydrogels to deliver essential oils (such as chamomile and basil) and natural moisturisers (such as Lu Hui (aloe vera), jasmine, lavender, palmarosa, and rose hip oil) to the surface of the skin. The presence of glycerol and polyethylene glycol esters in the sheet hydrogels enhances the solubility of essential oils and natural skin moisturisers.

Other Features

The pH of the gels used according to the invention is advantageously within the mildly acidic range e.g. 2.8-3.6. At this level, microbial activity in the cured product is low, and mould growth is not significant

The addition of small amounts of chloride salt, for example potassium chloride at 1-10 wt %, preferably 3-7 wt % also improves the electrical performance of hydrogels when they are being used for biomedical electrode application. It can conveniently be dissolved in the aqueous solution of the sulphonic monomer prior to polymerisation.

Conventional crosslinking agents may be used to provide the necessary mechanical integrity and control the adhesive properties of the formulation. Typical cross-linkers include polyethylene glycol (PEG 600) diacrylate and polyethylene glycol (PEG 400) diacrylate (both products of UCB Chemicals and marketed under the trade name of Ebecryl 11 and IRR 280). The level of crosslinker may range from 0.4% to 0.01%, ideally from 0.3% to 0.04%.

The addition of a small amount of hydrophobic pressure sensitive acrylic copolymer emulsion, such as Flexbond MV70H and Airflex 920, (both products of Air Products), was found to increase the surface tack of the hydrogel. Copolymers having very low glass transition temperatures (Tg) were found to provide better adhesion.

UV Curing

The development of the three-dimensional crossed-linked polymer network is achieved from UV assisted photopolymerisation from a mixture of water-soluble monomers. The preferred means of catalysing the reaction is through the use of UV photo-initiators.

A number of suitable UV photoinitiators have been employed in the polymerisation of monomers for adhesive hydrogels, such as 1-hydroxycyclohexyl phenyl ketone and 2-hydroxy-2-methyl-1-phenyl-1-propanone (both products of Ciba Speciality Chemicals and marketed under the trade names of Darocur 1173 and Irgacure 184, respectively). Darocur 1173 has good water solubility and is preferred to permit total or substantially total cure of monomers in the production of thick hydrogels (up to 2 mm), at a fast rate, allowing quick cross-linking by the water-soluble cross-linkers. Irgacure 184 is not normally used as a photoinitiator when water-soluble monomers are used because of its insolubility in water. Howeveri,the polyethylene glycol diacrylate cross-linkers have the ability to dissolve Irgacure 184, the solution being stable for use in polymerising water-soluble monomers. We have found that the use of both photoinitiators imparts enhanced bioadhesive properties to the hydrogel produced. We find that whereas Irgacure 184 provides hydrogel with good surface adhesion, Darocur 1173 has the ability to provide good bulk polymerisation. The use of Irgacure 754 and Irgacure 819 DW (both product of Ciba Speciality Chemicals and recently available in bulk) for producing bioadhesive hydrogels is believed to be novel.

SarCure 1129 type photoinitiators are preferably used as they exhibit high α-cleavage efficiency, which results in a high rate of cure. SarCure SR 1129 is a liquid mixture of an oligomeric α-hydroxyketone (oligomeric 2-hydroxy-2-methyl-1,4-(1-methylvinyl)-phenylpropanone) and 2-hydroxy-2-methyl-1-phenyl-1-propanone and is available from Sartomer Company, Inc of Exton, Pa., USA. Addition of a small quantity of SarCcure SR 1129 enhances the bioadhesive properties of the resulting hydrogel.

Unexpectedly, it was found that it was unnecessary to remove the high levels of inhibitors, such as MHEQ, used to stabilise the monomers from premature catalysis for preparation of sheet hydrogels, at reasonable rates of cure, using photopolymerisation technique.

The invention will now be further described in the following examples.

Chemicals Used

Monomers:

Acrylamido-2-Methyl-1-propane sulfonic acid sodium salt (50% aqueous solution)

i. From Lubrizol as L2405 (NaAMPS)

ii. From Toagosei as ATBS-Na
The 58% aqueous solution of NaAMPS/ATBS-Na, either from Lubrizol or Toagosei can also be used for these formulations.
Acryl-(3-sulfopropyl)-ester, potassium salt (SPA), from Raschig.
Acrylic acid from Tianjin Yuanli Chemical Co. Ltd
β-Carboxyethyl Acrylate, sold as Sipomer β CEA by Rhodia.
Methoxy polyethylene glycol (350) monoacrylate or 550 monoacrylate (sold as Sartomer CD-551 and Sartomer CD553, respectively by Sartomer).
Methoxy polyethylene glycol 350 methacrylate or 550 methacrylate (sold as Sartomer CD550 and Sartomer CD552, respectively by Sartomer).
(3-acrylamidopropyl) trimethylammonium chloride (ATC) (as 75% aqueous solution) from Sigma-Aldrich.
Acryloyloxy-ethyl trimethyl ammonium chloride as 80% aqueous solution (ARON DAC, from Toagosei Chemicals).
   Crosslinkers:

Ebecryl 11 (Polyethylene glycol (600) diacrylate)

IRR 280 (Polyethylene glycol (400) diacrylate) (both from UCB Chemicals.)

Photoinitiators:

Irgacure 184 [(1-hydroxy-cyclohexyl)-phenyl ketone] and

Darocur 1173 [2-hydroxy-2-methyl-1-phenylpropan-1-one] (both from Guangzhou Ciba Speciality Chemicals)

SarCure 1129 (from Sartomer Company Inc)

Plasticizers:

Glycerol

Polyethylene 400 Dilaurate (PEG 400 DL)

Polyethylene 400 Monolaurate (PEG 400 ML)

Polyethylene 600 Monolaurate (PEG 600 ML)

Polyethylene 400 Monooleate (PEG 400 MO)

Polyethylene 600 Monooleate (PEG 600 MO)

Polyethylene 400 Dioleate (PEG 400 DO)

Polyethylene 600 Dioleate (PEG 600 DO)

Tackifers:

Rosin ester (food grade) from Jiangsu Ganyu Rosin Factory, China.

Flexbond MV70H (Air Products)

Airflex 920 (Air Products)

BJ707 (Beijing Organic Chemical Plant)

BJ705 (Beijing Organic Chemical Plant)

Essential Oils and Natural Moisturisers:

i) Essential Oils

Basil, chamomile, jasmine, lavender, palmarosa and rose hip essential oils are obtained from Kobashi Ide, Devon, UK.

ii) Aloe Vera (Lu Hui)

In the form of 1:1, 10:1 gel or whole leaf concentrate or as 100:1 or 200:1 whole leaf freeze dried powder from Yunnan Yuanjiang Evergreen Biological Industry (Group) Co Ltd. Aloe vera freeze dried powder is preferred if a water limited formulation is required.

Method of Preparing Formulations:

Stage 1

Photoinitiator is dissolved in the cross linker (or monomers) or mixed with the crosslinker if a liquid photoinitiator is used. For example, in 30 parts of polyethylene glycol diacrylate (PEG 600) (product of UCB Chemicals and marketed under the trade name of Ebacyl 11), 6 parts of 1-hydroxycyclohexyl phenyl ketone (product of Ciba, trade name Irgacure 184) are dissolved to give the photoinitiator/crosslinker mix.

Stage 2:

KCl is mixed in ATBS-Na (or the NaAMPS), until dissolved, after which glycerol is added to the mixture, followed by polyethylene glycol 400 dioleate (if used). The remaining monomers (Sartomer CD550, DAC, CEA and acrylic acid) are added and the mixture is stirred after each addition.

Stage 3:

The photoinitiator/crosslinker mixture (appropriate level) is added to the mixture prepared in stage 2.

Stage 4:

Liquid mixture is poured onto siliconised PET sheet and placed under a medium pressure mercury UV lamp for 10 to 24 seconds.

### EXAMPLE 1 (COMPARATIVE)

Effect of Methoxy Polyethylene Glycol 350 Monomethacrylate (CD550)

The following resins were prepared using the technique described above.

| Reference | 1-1 | 1-2 | 1-3 |
|---|---|---|---|
| NaAMPS (50%) | 0 | 0 | 20 |
| Acryl-(3-sulfopropyl)-ester | 20 | 17.5 | 7.5 |
| (SPA) | | | |
| Acrylic Acid | 20 | 20 | 20 |
| Methoxypolyethylene glycol | 0 | 2.5 | 2.5 |
| monomethacrylate (CD550) | | | |
| Glycerol | 30 | 30 | 30 |
| Water | 30 | 30 | 20 |
| Irgacure184/Ebecryl11(6/20) | 0.12 | 0.12 | 0.12 |
| Cure time(s) | 12 | 12 | 12 |
| Monomer % | 40 | 40 | 40 |
| Water % | 30 | 30 | 30 |
| G′ Pa (300 rad/sec) | 13864.5 | 11485.5 | 3935.7 |
| G″ Pa (300 rad/sec) | 5268.32 | 4050.57 | 1422.34 |
| Tan delta | 0.37999 | 0.35267 | 0.36139 |

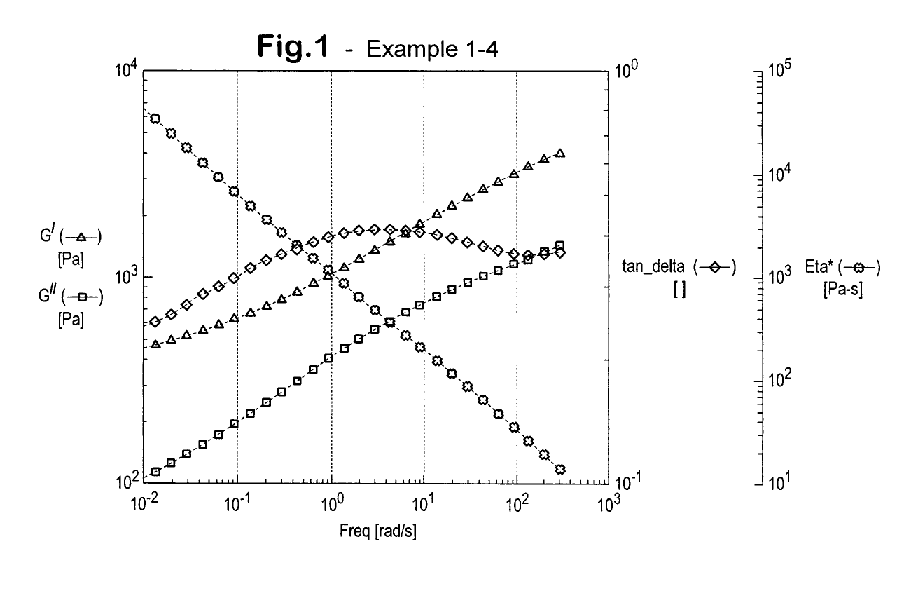

The gels of examples 1-1 and 1-2 were undesirably tough because of the high acrylic acid content. Use of NaAMPS and acryl-(3-sulfopropyl)-ester (SPA) together with methoxypolyethylene glycol monomethacrylate (CD 550) softened them somewhat, but skin adhesion was still poor. Rheology results for the composition of Example 1-3 appear below (FIG. 1).

### EXAMPLE 2

Effect of Methoxy Polyethylene Glycol 350 Monoacrylate (CD551) and Sipomer β (CEA)

The following resins were prepared using the technique described above, formed into electrodes and evaluated.

| Reference | 2-1 | 2-2 | 2-3 | 2-4 |
|---|---|---|---|---|
| ATBS-Na (50%) | 57 | 57 | 57 | 57 |
| Acrylic Acid | 3 | 3 | 3 | 3 |
| β-carboxyethyl acrylate | 6 | 5 | 4 | 3 |
| (CEA) | | | | |
| Methoxy polyethylene glycol | 1 | 2 | 3 | 4 |
| monoacrylate (CD551) | | | | |
| Glycerol | 33 | 33 | 33 | 33 |
| KCl | 5 | 5 | 5 | 5 |
| Irgacure 184/Ebecryl 11 | 0.14 | 0.14 | 0.14 | 0.14 |
| (6/30) | | | | |
| Cure time(s) | 12 | 12 | 12 | 12 |
| Monomer % | 38.5 | 38.5 | 38.5 | 38.5 |
| Water % | 28.5 | 28.5 | 28.5 | 28.5 |
| G′ Pa (300 rad/sec) | 1670.93 | | | 5544.10 |
| G″ Pa (300 rad/sec) | 903.790 | | | 3461.66 |
| Tan delta | 0.54089 | | | 0.62439 |

The combined effect of CEA and CD551 was to increase the re-usability of the hydrogel produced.

### EXAMPLE 3

Effect of Methoxy Polyethylene Glycol 350 Monoacrylate (CD551), Acryloyloxy-Ethyl Trimethyl Ammonium Chloride (DAC) and Sipomer β (CEA)

The following resins were prepared using the technique described above.

| Reference | 3-1 | 3-2 | 3-3 | 3-4 |
|---|---|---|---|---|
| ATBS-Na (50%) | 57 | 57 | 57 | 57 |
| Acrylic Acid | 3 | 3 | 3 | 3 |
| β-carboxyethyl acrylate (CEA) | 6 | 3 | 4 | 3 |
| Methoxy polyethylene glycol | 0 | 0 | 1 | 1 |
| monoacrylate (CD551) | | | | |
| Acryloyloxy-ethyl trimethyl | 1 | 4 | 2 | 5 |
| ammonium chloride (DAC) | | | | |
| Glycerol | 33 | 33 | 33 | 33 |
| KCl | 5 | 5 | 5 | 5 |
| Irgacure 184/Ebecryl 11 (6/30) | 0.14 | 0.14 | 0.14 | 0.14 |
| Cure time(s) | 12 | 12 | 12 | 12 |
| Monomer % | 38.3 | 37.7 | 38.1 | 37.5 |
| Water % | 28.7 | 29.3 | 28.9 | 29.5 |
| G′ Pa (300 rad/sec) | 3982.11 | 4574.2 | 5578.46 | 3684.4 |
| G″ Pa (300 rad/sec) | 2175.86 | 2553.52 | 2897.51 | 1857.05 |
| Tan delta | 0.54641 | 0.55824 | 0.51941 | 0.50403 |

Increasing content of acryloyloxy-ethyl trimethyl ammonium chloride (DAC) lead to an increase in the toughness of the electrode gels, but decreased their capacity to absorb water, so that their ability to adhere to the skin of a subject who was perspiring was reduced. The combined effects of DAC and CEA was to increase the toughness of the resulting gels, but their skin adhesion properties were only moderately good, with some improvement in the reusability of the resulting gel. Gels containing CD551 had improved flexibility and other properties.

### EXAMPLE 4

Effect of High Monomer Content

The following resins were prepared using the technique described above.

| Sample | 4-1 | 4-2 | 4-3 |
|---|---|---|---|
| ATBS-Na (50%) | 59 | 54 | 49 |
| Acrylic Acid | 3 | 3 | 3 |
| Methoxy polyethylene glycol | 1 | 1 | 1 |
| monoacrylate (CD551) | | | |
| (3-acrylamidopropyl) trimethyl- | 5 | 10 | 15 |
| ammonium chloride (ATC) | | | |
| Glycerol | 30 | 30 | 30 |
| PEG400MO | 2 | 2 | 2 |
| Irgacure 184/Ebecryl 11 (6/20) | 0.10 | 0.10 | 0.10 |
| Cure time(s) | 12 | 12 | 12 |
| Monomer % | 37.25 | 38.5 | 39.75 |
| Water % | 30.75 | 29.5 | 28.25 |

The above gels exhibited relatively poor adhesion properties because of the high content of ATC monomer.

### EXAMPLE 5

Effect of High Monomer Content

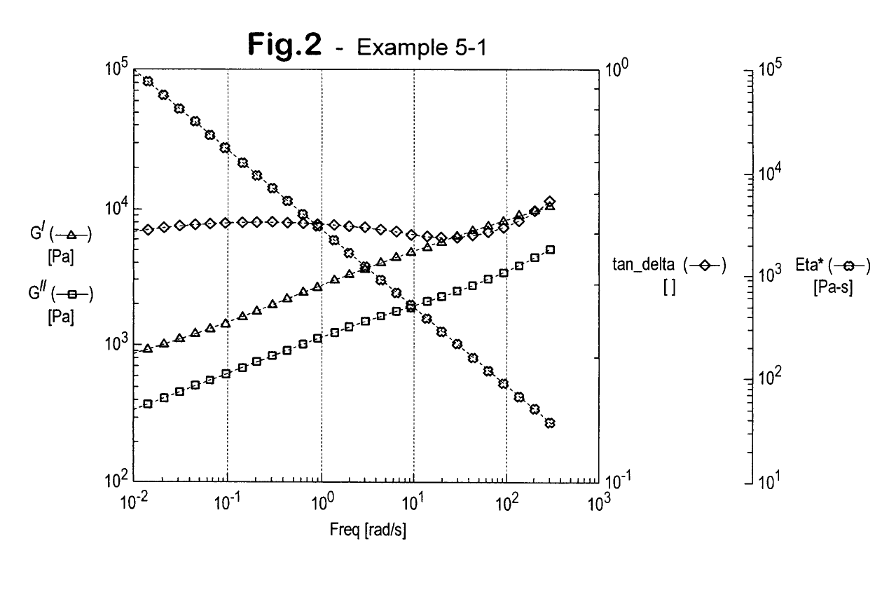

The following resins were prepared using the technique described above.

| Reference | 5-1 | 5-2 | 5-3 |
|---|---|---|---|
| ATBS-Na (50%) | 49 | 62 | 53 (58% ATBS-Na) |
| Acryl-(3-sulfopropyl)-ester (SPA) | 8 | 0 | 6 |
| Acrylic acid | 5 | 3 | 3 |
| β-carboxyethyl | 0 | 5 | 5 |
| acrylate (CEA) | | | |
| Methoxy polyethylene glycol | 1 | 0 | 0 |
| monoacrylate (CD551) | | | |
| (3-acrylamidopropyl)trimethyl- | 5 | 0 | 1 |
| ammonium chloride (ATC) | | | |
| Glycerol | 30 | 30 | 30 |
| PEG400MO | 2 | 0 | 2 |
| Irgacure 184/Ebecryl 11 (6/20) | 0.14 | 0.14 | 0.14 |
| Cure time(s) | 12 | 12 | 12 |
| Monomer % | 42.25 | 39 | 45.44 |
| Water % | 25.75 | 31 | 22.56 |
| G′ Pa (300 rad/sec) | 10272.3 | 8448.13 | |
| G″ Pa (300 rad/sec) | 4951.53 | 5027.14 | |
| Tan delta | 0.48203 | 0.59506 | |

Where the level of ATC was more than 1%, the resulting gel had low skin adhesion, but good electrical properties. When the monomer level was more than 45% (and contained low levels of ATC), the resulting gel had good adhesion to skin. It is possible that the small level of PEG400 MO is sufficient for it to behave as a surfactant in these formulations. Rheology results for the composition of Example 5-1 appear below (FIG. 2).

### EXAMPLE 6

Effect of CEA

The following resins were prepared using the technique described above.

| | Reference | | | | | | |
|---|---|---|---|---|---|---|---|
| | 6-1 | 6-2 | 6-3 | 6-4 | 6-5 | 6-6 | 6-7 |
| ATBS-Na (50%) | 62 | 62 | 60 | 60 | 68 | 65 | 60 |
| Acryl-(3-sulfopropyl)- | 0 | 0 | 2 | 0 | 0 | 0 | 0 |
| ester (SPA) | | | | | | | |
| Acrylic Acid | 3 | 3 | 3 | 3 | 3 | 3 | 3 |
| β-carboxyethyl | 5 | 5 | 5 | 8 | 0 | 0 | 8 |
| acrylate (CEA) | | | | | | | |
| Methoxy polyethylene | 0 | 0 | 0 | 0 | 0 | 2 | 0.5 |
| glycol monoacrylate | | | | | | | |
| (CD551) | | | | | | | |
| Glycerol | 30 | 28 | 29 | 28 | 29 | 28 | 28 |
| PEG400DL | 0 | 2 | 1 | 1 | 0 | 2 | 0.5 |
| Irgacure 184/ | 0 | 0 | 0 | 0.12 | 0.12 | 0.12 | 0.12 |
| Ebecryl 11 (6/30) | | | | | | | |
| Darocur 1173/ | 0.12 | 0.12 | 0.12 | 0 | 0 | 0 | 0 |
| Ebecryl 11 (6/20) | | | | | | | |
| Sarcure 1129 | 0.1 | 0.1 | 0.1 | 0.1 | 0.1 | 0.1 | 0.1 |
| Darocur 1173 | 0 | 0 | 0 | 0 | 0 | 0.01 | 0.01 |
| Cure time(s) | 12 | 12 | 12 | 12 | 12 | 12 | 12 |
| Monomer % | 39 | 39 | 40 | 41 | 37 | 37.5 | 41.5 |
| Water % | 31 | 31 | 30 | 30 | 34 | 32.5 | 30 |
| G′ Pa (300 rad/sec) | | | | 3529.54 | 4596.2 | 5794.98 | |
| G″ Pa (300 rad/sec) | | | | 1819.36 | 2570.6 | 4094.16 | |
| Tan delta | | | | 0.51547 | 0.5592 | 0.70650 | |

The above gels exhibited good skin adhesion properties. Sample 6-7 had the highest adhesion due to having low water content but high monomer content.

### EXAMPLE 7

Effect of ATC

The following resins were prepared using the technique described above.

| Reference | 7-1 | 7-2 | 7-3 |
|---|---|---|---|
| ATBS-Na (50%) | 59 | 54 | 49 |
| Acrylic Acid | 3 | 3 | 3 |
| Methoxy polyethylene glycol | 1 | 1 | 1 |
| monoacrylate (CD551) | | | |
| (3-acrylamidopropyl) trimethyl | 5 | 10 | 15 |
| ammonium chloride (ATC) | | | |
| Glycerol | 30 | 30 | 30 |
| PEG400MO | 2 | 2 | 2 |
| KCl | 3 | 3 | 3 |
| Irgacure 184/Ebecryl 11 (6/20) | 0.10 | 0.10 | 0.10 |
| Cure time(s) | 12 | 12 | 12 |
| Monomer % | 37.25 | 38.5 | 39.75 |
| Water % | 30.75 | 29.5 | 28.25 |

The addition of ATC increased the electrical performance of the resulting gel, but their skin adhesion properties were poor.

### EXAMPLE 8

Effect of Photoinitiator and Cross-Linker Level

The following resins were prepared using the technique described above.

| Reference | 8-1 | 8-2 | 8-3 | 8-4 |
|---|---|---|---|---|
| NaAMPS (50%) | 62 | 62 | 60 | 60 |
| Acryl-(3-sulfopropyl)- | 0 | 0 | 2 | 2 |
| ester (SPA) | | | | |
| Acrylic Acid | 3 | 3 | 3 | 3 |
| β-carboxyethyl acrylate | 5 | 5 | 5 | 5 |
| (CEA) | | | | |
| Glycerol | 30 | 30 | 29 | 29 |
| KCl | 3 | 3 | 3 | 3 |
| PEG400DL | 0 | 0 | 1 | 1 |
| Irgacure 184/Ebecryl 11 | 0.10 | 0 | 0.15 | 0.20 |
| (6/20) | | | | |
| Darocur 1173/Ebecryl 11 | 0 | 0.10 | 0 | 0 |
| (6/20) | | | | |
| Darocur 1173 | 0 | 0 | 0.10 | 0.10 |
| Cure time(s) | 12 | 12 | 12 | 12 |
| Monomer % | 39 | 39 | 40 | 40 |
| Water % | 31 | 31 | 30 | 30 |
| G′ Pa (300 rad/sec) | | | 6277.48 | 9995.33 |
| G″ Pa (300 rad/sec) | | | 4796.45 | 6977.13 |
| Tan delta | | | 0.76407 | 0.69804 |

The resulting gels had reasonable adhesion properties. Increase in the cross-linker level resulted in the gel being slightly harder.

### EXMPLE 9

Effect of SPA and CD 550

The following resins were prepared using the technique described above.

| Reference | 9-1 | 9-2 | 9-3 | 9-4 |
|---|---|---|---|---|
| ATBS-Na (50%) | 64 | 56 | 64 | 60 |
| Acryl-(3-sulfopropyl)-ester | 0 | 8 | 0 | 2 |
| (SPA) | | | | |
| Acrylic Acid | 2 | 2 | 2 | 2 |
| β-carboxyethyl acrylate | 2 | 2 | 1 | 2 |
| (CEA) | | | | |
| Methoxypolyethylene glycol | 0 | 0 | 1 | 2 |
| monomethacrylate (CD550) | | | | |
| Glycerol | 30 | 30 | 30 | 30 |
| PEG400DL | 2 | 2 | 2 | 2 |
| KCl | 3 | 3 | 3 | 3 |
| Ir184/Eb11(6/20) | 0.12 | 0.12 | 0.18 | 0.18 |
| Cure time(s) | 12 | 12 | 12 | 12 |
| Monomer % | 36 | 40 | 36 | 38 |
| Water % | 32 | 28 | 32 | 30 |
| G′ Pa (300 rad/sec) | 4784.21 | 13375.7 | | |
| G″ Pa (300 rad/sec) | 2924.60 | 7973.45 | | |
| Tan delta | 0.61130 | 0.59612 | | |

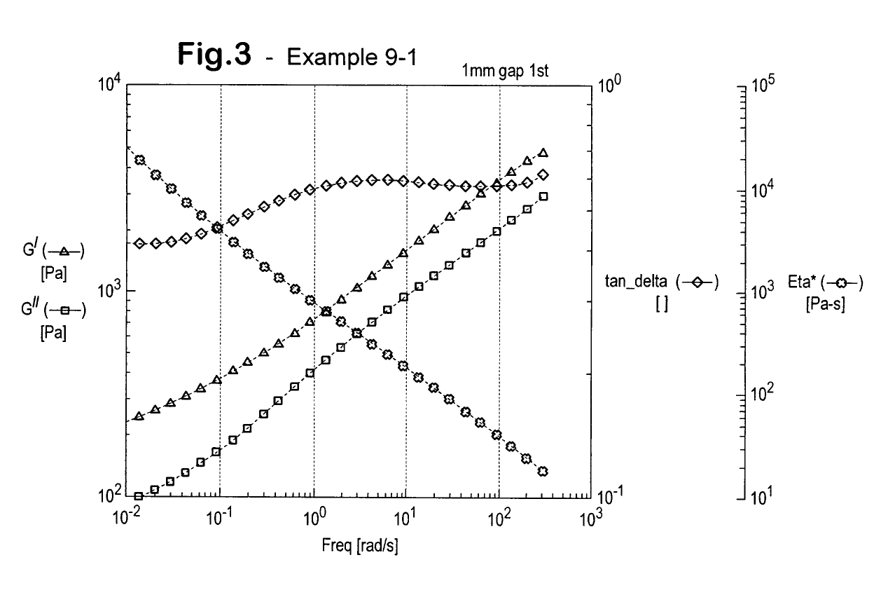

The combination of SPA and CD550 resulted in gels that were soft and reusable. Rheology results for the composition of Example 9-1 appear below (FIG. 3). Skin adhesion, re-usability and softness were rated fairly good.

### EXAMPLE 10

Effect of Tackifer

The following resins were prepared using the technique described above.

| Reference | 10-1 | 10-2 | 10-3 | 10-4 |
|---|---|---|---|---|
| ATBS-Na (50%) | 46 | 46 | 46 | 44 |
| Acrylic Acid | 3 | 3 | 4 | 4 |
| β-carboxyethyl acrylate (CEA) | 8 | 8 | 8 | 8 |
| Methoxy polyethylene glycol | 0 | 0 | 0.5 | 0.5 |
| monoacrylate (CD551) | | | | |
| Acryloyloxy-ethyl trimethyl | 0 | 0 | 1 | 3 |
| ammonium chloride (DAC) | | | | |
| Glycerol | 28 | 28 | 25.5 | 25.5 |
| KCl | 3 | 3 | 3 | 3 |
| BJ707 | 0 | 0 | 15 | 15 |
| Flexbond MV70H | 15 | 0 | 0 | 0 |
| Airflex 920 | 0 | 15 | 0 | 0 |
| Irgacure 184/Ebecryl 11 (6/30) | 0.12 | 0.12 | 0.12 | 0.12 |
| Monomer % | 41.5 | 41.5 | 43.8 | 44.4 |
| Water % | 30.5 | 30.5 | 30.7 | 30.1 |
| G′ Pa (300 rad/sec) | | | 9636.26 | |
| G″ Pa (300 rad/sec) | | | 4356.61 | |
| Tan delta | | | 0.45211 | |

The addition of Flexbond Mv70H (a polymer emulsion believed to be based on vinyl acetate-maleic acid ester copolymers) and Airflex 920 (a −20° C. Tg carboxylated vinyl acetate-ethylene (VAE) copolymer emulsion) had the effect of increasing the skin adhesion of the gel. Both of these materials are available from Air products. The tackifer BJ707 had little effect in increasing the skin adhesion of the gel.

### EXAMPLE 11

Addition of Aloe Vera

The following resin was prepared using the technique described above:

| Reference | 11-1 |
|---|---|
| ATBS-Na (50%) | 62 |
| Acrylic acid | 1 |
| Methoxypolyethylene glycol monomethactylate | 1.9 |
| (CD550) | |
| Glycerol | 30 |
| PEG400DL | 3 |
| Aloe Vera (freeze dried whole leaf powder 200:1) | 0.1 |
| Irgacure 184/Ebecryl 11(6/20) | 0.12 |
| Cure time(s) | 12 |
| Monomer % | 33.9 |
| Water % | 31.1 |
| G′ Pa (300 rad/sec) | 5778.2 |
| G″ Pa (300 rad/sec) | 4163.91 |
| Tan delta | 0.72061 |

The gel had a cool, soft feeling and low adhesion to the skin.

1.-32. (canceled)

33. A bioadhesive composition consisting essentially of:
(a) about 28-60 wt % of a copolymer component comprising repeating units derived from copolymerizing at least two members selected from the group consisting of: (i) one or more monomers selected from olefinically unsaturated sulphonic acids; (ii) one or more olefinically unsaturated carboxylic acids, the ratio by weight of the sulphonic acid units to the carboxylic acid units being in a range from about 30:1 to 1:1, and (iii) an alkoxy polyethyleneglycol acrylate or methacrylate;
(b) about 20-45 wt % of a plasticizer component; and
(c) about 10-55 wt % of water.

34. The composition of claim 33, wherein the copolymer component comprises one or more sulphonic acid units selected from the group consisting of:
(a) 2-acrylamido-2-methyl-propanesulphonic acid or a salt thereof;
(b) 2-acrylamido-2-methyl-propanesulphonic acid sodium salt (NaAMPS or ATBS-Na); and,
(c) 3-sulphopropyl acrylate (SPA) or a salt or analog thereof.

35. The composition of claim 33, wherein the copolymer component comprises carboxylic acid units selected from the group consisting of acrylic acid, methacrylic acid and mixtures thereof.

36. The composition of claim 33, wherein the copolymer component comprises about 32-52 wt % of the composition.

37. The composition of claim 33, wherein the copolymer component comprises sulphonic acid units and carboxylic acid units in a weight ratio of about 2.5:1 to about 12:1 of sulphonic acid to carboxylic acid units.

38. The composition of claim 33, wherein the copolymer component includes an alkoxy polyethyleneglycol acrylate or methacrylate component selected from the group consisting of methoxy polyethylene glycol monoacrylate and methoxy polyethylene glycol monomethacrylate.

39. The composition of claim 33, wherein the composition includes alkoxy polyethylene glycol acrylate or methacrylate in an amount of about 1-10 wt % of the composition.

40. The composition of claim 33, wherein the composition includes copolymerised β-carboxyethyl acrylate in an amount of about 1-10 wt % of the composition.

41. The composition of claim 33, wherein the plasticizer component comprises about 25-45 wt % of the composition.

42. The composition of claim 41, wherein the plasticizer component comprises a water-soluble polyhydric alcohol that is liquid at ambient temperatures.

43. The composition of claim 42, wherein the plasticizer component comprises glycerol or a mixture of glycerol and one or more other polyols.

44. The composition of claim 33, wherein the composition includes a mono- or diester of polyethylene glycol.

45. The composition of claim 44, wherein the composition includes a mono- or diester of polyethylene glycol with lauric acid, myristic acid, palmitic acid, stearic acid, oleic acid, arachidic acid or erucic acid.

46. The composition of claim 33, wherein the composition comprises about 10-35 wt % water.

47. The composition of claim 33, wherein the composition comprises about 25-32 wt % water.

48. The composition of claim 33, wherein the composition includes a cationic olefinic comonomer selected from copolymerised acryroyl oxyethyl trimethyl ammonium chloride and 3-acrylamidopropyl trimethyl ammonium chloride in an amount of 0.1% to 15 wt % of the composition.

49. The composition of claim 48, wherein the catonic olefinic comonomer is present in an amount of 0.1% to 5 wt % of the composition.

50. A bioadhesive composition consisting essentially of a hydrogel mixture selected from the group consisting of mixture A, mixture B and mixture C as follows:
Mixture A:
(A1) about 28-60 wt % of a polymer based on repeating units derived from one or more monomers selected from olefinically unsaturated sulphonic acids;
(A2) about 20-45 wt % of a plasticizer(s);
(A3) about 10-55 wt % of water; and,
(A4) at least one member selected from an alkoxy polyethyleneglycol acrylate, methacrylate and β-carboxyethyl acrylate, acryroyl oxyethyl trimethyl ammonium chloride or 3-acrylamidopropyl trimethyl ammonium chloride, the balance of the composition being electrolyte and optional ingredients;
Mixture B:
(B1) a copolymer comprising repeating units derived from (i) one or more monomers selected from olefinically unsaturated sulphonic acids; and (ii) one or more olefmically unsaturated carboxylic acids, the ratio by weight of the sulphonic acid units to the carboxylic acid units being from about 30:1 to about 1:1;
(B2) a water-soluble polyhydric alcohol that is liquid at ambient temperatures;
(B3) a mono- or di-ester of polyethylene glycol with lauric, myristic, palmitic, stearic, oleic, arachidic or erucic acid; and, (B4) water; and,
Mixture C:
(C1) a copolymer comprising repeating units derived from: (i) one or more monomers selected from olefinically unsaturated sulphonic acids; (ii) one or more olefinically unsaturated carboxylic acids, the ratio by weight of the sulphonic acid units to the carboxylic acid units being from 30:1 to 1: 1; and (iii) β-carboxyethyl acrylate;
(C2) a plasticiser; and,
(C3) water.

51. A medical device comprising a layer of a bioadhesive composition according to claim 33.

52. A medical device according to claim 51, wherein said device is selected from the group consisting of medical electrodes and medical bandages.
